(19) United States
(12) Patent Application Publication
(10) Pub. No.: US 2024/0340749 A1
(43) Pub. Date: Oct. 10, 2024

(54) METHODS PERFORMED BY USER EQUIPMENT AND BASE STATION

(71) Applicant: SAMSUNG ELECTRONICS CO., LTD., Suwon-si (KR)

(72) Inventors: Yanze FU, Beijing (CN); Haijie QIU, Beijing (CN)

(21) Appl. No.: 18/627,391

(22) Filed: Apr. 4, 2024

(30) Foreign Application Priority Data
Apr. 7, 2023 (CN) 202310371220.4

(51) Int. Cl. H04W 36/32; H04W 64/00

(52) U.S. Cl. CPC H04W 36/322; H04W 64/00

(57) ABSTRACT

The disclosure relates to a 5G or 6G communication system for supporting a higher data transmission rate. A method performed by a user equipment (UE) in a wireless communication system is provided. The method comprises receiving, from a base station, a system information block (SIB) including information on a threshold for a location-based measurement in a radio resource control (RRC) idle or RRC inactive and information on a reference location of a serving cell and in case that a distance between the UE in the RRC idle or the RRC inactive and the reference location of the serving cell is larger than the threshold, performing the location-based measurement for cell reselection

### CROSS-REFERENCE TO RELATED APPLICATION

This application is based on and claims priority under 35 U.S.C. § 119 to Chinese Patent Application No. 202310371220.4 filed on Apr. 7, 2023, in the China Intellectual Property Office, the disclosure of which is incorporated by reference herein in its entirety.

### BACKGROUND

### 1. Field

The present disclosure generally relates to a wireless communication technology, and in particular, to methods performed by a user equipment and a base station, and a user equipment in a wireless communication system.

### 2. Description of Related Art

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

A method performed by a user equipment (UE) in a wireless communication system is provided. The method comprises receiving, from a base station, a system information block (SIB) including information on a threshold for a location-based measurement in a radio resource control (RRC) idle or RRC inactive and information on a reference location of a serving cell and in case that a distance between the UE in the RRC idle or the RRC inactive and the reference location of the serving cell is larger than the threshold, performing the location-based measurement for cell reselection.

A user equipment (UE) in a wireless communication system is provided. The UE comprises a transceiver and a controller coupled with the transceiver and configured to receive, from a base station, a system information block (SIB) including information on a threshold for a location-based measurement in a radio resource control (RRC) idle or RRC inactive and information on a reference location of a serving cell, and in case that a distance between the UE in the RRC idle or the RRC inactive and the reference location of the serving cell is larger than the threshold, perform the location-based measurement for cell reselection.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network in accordance with various embodiments of the present disclosure;

FIG. 2A illustrates an example of wireless transmission and reception paths according to various embodiments of the present disclosure;

FIG. 2B illustrates an example of wireless transmission and reception paths according to various embodiments of the present disclosure;

FIG. 3A illustrates an example of UE according to various embodiments of the present disclosure;

FIG. 3B illustrates an example of gNB according to various embodiments of the present disclosure;

FIG. 4 illustrates an example of flowchart of a cell measurement process according to various embodiments of the present disclosure;

FIG. 5 illustrates yet another example of flowchart of a cell measurement process according to various embodiments of the present disclosure;

FIG. 6 illustrates an example of a scenario in which cell measurement is performed according to various embodiments of the present disclosure; and

FIG. 7 illustrates yet another example of flowchart of a cell measurement process according to various embodiments of the present disclosure.

### DETAILED DESCRIPTION

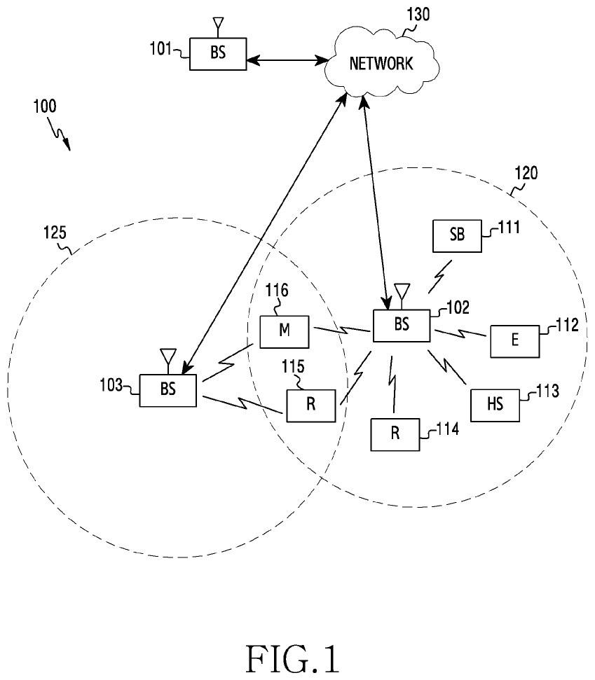

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. In addition, the terms such as “include” and/or “have” may be construed to denote a certain characteristic, number, step, operation, constituent element, component, or a combination thereof, but may not be construed to exclude the existence of or a possibility of addition of one or more other characteristics, numbers, steps, operations, constituent elements, components, or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems.”

In order to achieve a higher data rate, 5G communication systems are implemented in higher frequency (millimeter, mmWave) bands, e.g., 60 GHz bands. In order to reduce propagation loss of radio waves and increase transmission distance thereof, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments for system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, or the like.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

According to an aspect of the present disclosure, a method performed by a user equipment UE in a wireless communication system is provided. The method may include: receiving first information from a base station, wherein the first information may at least include a cell stop time of a serving cell; and stopping, by the UE, measurement of a neighbouring cell before a second time, wherein the second time is determined based on the first information.

In some examples, in the method performed by the UE, the second time may be determined based on the first information and an offset.

In some examples, in the method performed by the UE, when a moving direction of the UE meets a first condition, the second time is determined by subtracting the offset from the cell stop time contained in the first information; otherwise, the second time is determined by adding the offset to the cell stop time contained in the first information.

In some examples, in the method performed by the UE, the first condition may include: the moving direction of the UE is opposite to a moving direction of the serving cell.

In some examples, in a method performed by the UE, the offset may be one of: a predetermined value; a value determined based on a mapping table of a UE velocity to the offset; and a value determined based on a predetermined function, wherein the predetermined function is related to at least one of: a coverage range of the serving cell, a UE location, a moving direction of the UE, a moving velocity of the UE, a location of the serving cell, a moving direction of the serving cell, and a moving velocity of the serving cell.

According to another aspect of the present disclosure, a method performed by a base station in a wireless communication system is provided. The method may include: sending first information to a user equipment UE, wherein the first information at least includes a cell stop time of a serving cell; and stopping, by the UE, measurement of a neighbouring cell before a second time, wherein the second time is determined based on the first information.

According to another aspect of the present disclosure, a method performed by a user equipment UE in a wireless communication system is provided. The method may include: receiving first information from a base station; and determining whether to perform measurement of a neighbouring cell according to the first information, wherein the first information includes time information of a reference location of a serving cell.

In some examples, in the method performed by the UE, the first information may also include a first distance threshold or a third distance threshold of the serving cell, or a list of neighbouring cells, wherein the list of neighbouring cells includes the time information of a reference location of each neighbouring cell and a second distance threshold.

In some examples, in the method performed by the UE, in a case where the first information may include the time information of the reference location of the serving cell and the first distance threshold, the determining whether to perform measurement of the neighbouring cell includes at least one of: stopping, by the UE, measurement of the neighbouring cell before the second time, wherein the second time is determined based on the first information and the offset; performing measurement of the neighbouring cell when a distance from a UE location to the reference location of the serving cell is less than or equal to the first distance threshold at the first time, and a distance from a UE location to an expected reference location of the serving cell is greater than the first distance threshold at a third time; and not performing measurement of the neighbouring cell in a case that the distance from the UE location to the reference location of the serving cell is less than or equal to the first distance threshold at the first time, and the distance from the UE location to the expected reference location of the serving cell is less than or equal to the first distance threshold at the third time.

In some examples, in the method performed by the UE, in a case where the first information may include the time information of the reference location of the serving cell, time information of a reference location of a neighbouring cell, and the second distance threshold, the determining whether to perform measurement of the neighbouring cell includes at least one of: stopping, by the UE, measurement of the neighbouring cell before the second time, wherein the second time is determined based on the first information and the offset; not performing measurement of the neighbouring cell, or relaxing measurement of the neighbouring cell, in a case that a distance from the UE location to the reference location of the neighbouring cell is greater than the second distance threshold at the first time, a distance from a UE location to an expected reference location of the neighbouring cell is greater than a distance from the UE location to an expected reference location of the serving cell at a fifth time, and a priority of the neighbouring cell is lower than or equal to a priority of the serving cell; performing measurement of the neighbouring cell in a case that the distance from the UE location to the reference location of the neighbouring cell is greater than the second distance threshold at the first time, and the distance from the UE location to the expected reference location of the neighbouring cell is less than the distance from the UE location to the expected reference location of the serving cell at a fifth time, and the priority of the neighbouring cell is higher than, equal to, or lower than the priority of the serving cell; performing measurement of the neighbouring cell in a case that the distance from the UE location to the expected reference location of the neighbouring cell is greater than the distance from the UE location to the expected reference location of the serving cell at a fifth time, and the priority of the neighbouring cell is higher than the priority of the serving cell.

In some examples, in the method performed by the UE, in a case that the first information may include the time information of the reference location of the serving cell and the third distance threshold, the determining whether to perform measurement of the neighbouring cell includes at least one of: stopping, by the UE, measurement of the neighbouring cell before the second time, wherein the second time is determined based on the first information and the offset; performing measurement of the neighbouring cell according to a relaxed measurement period in a case that the distance from the UE location to the reference location of the serving cell is less than or equal to the third distance threshold at the first time, and, a distance from the UE location to an expected reference location of the serving cell is less than or equal to the third distance threshold at a seventh time; and/or performing measurement of the neighbouring cell in a case that the distance from the UE location to the reference location of the serving cell is greater than the third distance threshold at the first time; performing measurement of the neighbouring cell in a case that the distance from the UE location to the reference location of the serving cell is less than or equal to the third distance threshold at the first time, and the distance from the UE location to the expected reference location of the serving cell is greater than the third distance threshold at the seventh time.

In some examples, in the method performed by the UE, the UE location is determined based on a moving direction and a moving velocity of the UE in a case that the velocity of the UE is greater than or equal to a specific threshold.

In some examples, in the method performed by the UE, the relaxed measurement period is based on a predetermined value, wherein the predetermined value is greater than a normal measurement period.

In some examples, in the method performed by the UE, the first distance threshold is a distance threshold for a normal measurement; the second distance threshold is a distance threshold for measurement of the neighbouring cell; and the third distance threshold is a distance threshold for a relaxed measurement.

In some examples, in the method performed by the UE, the first information further includes at least one of: a type of the serving cell, a cell stop time of the serving cell, a coverage area size of the serving cell, a beam direction and a coverage angle of the serving cell, a beam direction and a coverage angle of the neighbouring cell, and an angle threshold.

In some examples, in the method performed by the UE, the third time is a time after receiving N3 discontinuous reception DRX cycles.

In some examples, in the method performed by the UE, the fifth time is a time after receiving N2 discontinuous reception DRX cycles.

In some examples, in the method performed by the UE, the seventh time is a time after receiving N4 discontinuous reception DRX cycles.

In some examples, in the method performed by the UE, the reference location of the serving cell is related to an altitude of the UE.

According to yet another aspect of the present disclosure, a method performed by a base station in a communication system is provided. The method may include: transmitting first information to a user equipment UE; and receiving uplink transmission signaling from the UE; wherein the first information is used by the UE to determine whether to perform measurement of a neighbouring cell, wherein the first information includes time information of a reference location of a serving cell.

In some examples, in the method performed by the base station, the first information may further include at least one of: a first distance threshold of the serving cell, a third distance threshold of the serving cell, a type of the serving cell, a cell stop time of the serving cell, a coverage area size of the serving cell, a beam direction and a coverage angle of the serving cell, a list of neighbouring cells, a beam direction and a coverage angle of the neighbouring cell, an angle threshold, wherein the list of neighbouring cells includes time information of a reference location of each neighbouring cell and a second distance threshold.

According to another aspect of the present disclosure, a method performed by a user equipment UE in a wireless communication system is provided. The method may include: receiving first information from a base station; and determining whether to perform measurement of a neighbouring cell based on the first information, wherein the first information includes a beam direction and a beam coverage range of a serving cell and/or the neighbouring cell.

In some examples, in the method performed by the UE, the determining whether to perform measurement of the neighbouring cell includes at least one of: stopping, by the UE, measurement of the neighbouring cell before a second time, the second time being determined based on the first information and an offset; performing measurement of the neighbouring cell when the UE is within a viewing range of a satellite; otherwise, not performing measurement of the neighbouring cell.

According to another aspect of the present disclosure, a method performed by a user equipment UE in a wireless communication system is provided. The method may include: receiving first information from a base station; and determining whether to perform measurement of a neighbouring cell based on the first information, wherein the first information includes a reference location list and a distance threshold list of a serving cell, and each reference location in the list or each distance threshold in the list corresponds to specific altitude ranges.

In some examples, in the method performed by the base station, the determining whether to perform measurement of the neighbouring cell based on the first information includes: determining, by the UE, whether to perform measurement of the neighbouring cell based on a reference location and a distance threshold corresponding to the altitude of the UE.

According to yet another aspect of the present disclosure, a method performed by a user equipment UE in a wireless communication system is provided. The method may include: receiving first information from a base station; and determining whether to perform measurement of a neighbouring cell according to the first information, wherein the first information includes a reference location and a distance threshold of a serving cell, and the reference location and the distance threshold of the serving cell is used by the UE to determine a reference location and a distance threshold corresponding to an altitude of the UE.

According to yet another aspect of the present disclosure, a user equipment UE is provided. The UE may include: a transceiver for transmitting and receiving signals; and a controller coupled to the transceiver and configured to perform the methods performed by the UE as described above.

According to yet another aspect of the present disclosure, a base station is provided. The base station may include: a transceiver for transmitting and receiving signals; and a controller coupled to the transceiver and configured to perform the methods performed by the base station as described above.

According to yet another aspect of the present disclosure, a computer-readable medium with instructions stored thereon is provided, wherein the instructions, when executed by a controller or processor, cause the controller or processor to perform the operations of the methods perform by the UE and/or the base station as described above.

FIG. 1 illustrates an example of wireless network 100 according to various embodiments of this disclosure. The embodiment of the wireless network 100 shown in FIG. 1 is for illustration only. Other embodiments of the wireless network 100 may be used without departing from the scope of this disclosure.

The wireless network 100 includes a gNodeB (gNB) 101, a gNB 102, and a gNB 103. The gNB 101 communicates with the gNB 102 and the gNB 103. The gNB 101 also communicates with at least one Internet Protocol (IP) network 130, such as the Internet, a private IP network, or other data networks.

Depending on the type of the network, other well-known terms such as “base station” or “access point” may be used instead of “gNodeB” or “gNB.” For convenience, the terms “gNodeB” and “gNB” are used herein to refer to a network infrastructure component that provides wireless access for remote terminals. In addition, depending on the type of the network, other well-known terms such as “mobile station,” “user station,” “remote terminal,” “wireless terminal” or “user apparatus” may be used instead of “user equipment” or “UE.” For convenience, the terms “user equipment” and “UE” are used herein to refer to a remote wireless devices that wirelessly accesses the gNB, no matter whether the UE is a mobile device (such as a mobile phone or a smart phone) or a common fixed device (such as a desktop computer or a vending machine).

The gNB 102 provides wireless broadband access to the network 130 for a first plurality of user equipments (UE) within a coverage area 120 of the gNB 102. The first plurality of UEs include: a UE 111, which may be located in a small business (SB); a UE 112, which may be located in an enterprise (E); a UE 113, which may be located in a Wi-Fi hotspot (HS); a UE 114, which may be located in a first residence (R); a UE 115, which may be located in a second residence (R); a UE 116, which may be a mobile device (M), such as a cellular phone, a wireless laptop computer, a wireless PDA, or the like. The gNB 103 provides wireless broadband access to network 130 for a second plurality of UE within a coverage area 125 of the gNB 103. The second plurality of UEs include a UE 115 and a UE 116. In some embodiments, one or more of the gNBs 101-103 may communicate with each other and with the UEs 111-116 by using 5G, long term evolution (LTE), LTE-A, WiMAX, or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including abnormal shapes, depending on configurations of the gNBs and changes in the radio environment associated with natural obstacles and man-made obstacles.

As will be described in more detail below, one or more of the gNB 101, the gNB 102, and the gNB 103 include a 2D antenna array as described in embodiments of this disclosure. In some embodiments, one or more of the gNB 101, the gNB 102, and the gNB 103 support codebook designs and structures for systems with 2D antenna arrays.

Although FIG. 1 illustrates an example of the wireless network 100, various changes may be made to FIG. 1. For example, the wireless network 100 may include any number of gNBs and any number of UEs in any suitable arrangement. Furthermore, the gNB 101 may directly communicate with any number of UEs and provide wireless broadband access to the network 130 for those UEs. Similarly, each of the gNB 102-103 may directly communicate with the network 130 and provide direct wireless broadband access to the network 130 for the UEs. In addition, the gNBs 101, 102 and/or 103 may provide access to other or additional external networks, such as external telephone networks or other types of data networks.

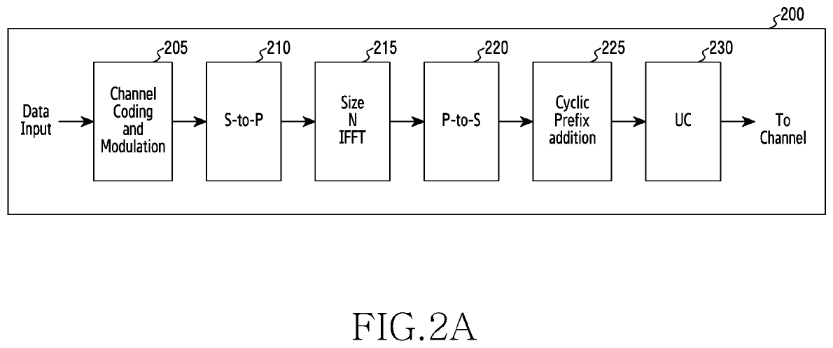

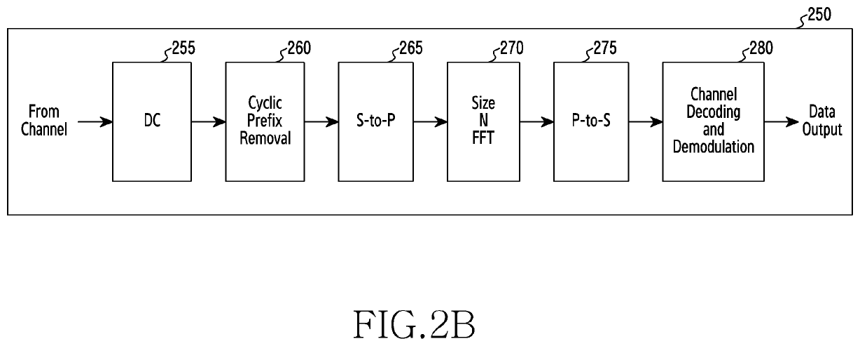

FIGS. 2A and 2B illustrate example wireless transmission and reception paths according to this disclosure. In the following description, a transmission path 200 may be described as being embodied in a gNB, such as the gNB 102, and a reception path 250 may be described as being embodied in a UE, such as the UE 116. However, it should be understood that the reception path 250 may be embodied in a gNB and the transmission path 200 may be embodied in a UE. In some embodiments, the reception path 250 is configured to support codebook designs and structures for systems with 2D antenna arrays as described in embodiments of this disclosure.

The transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. The reception path 250 includes a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The serial-to-parallel (S-to-P) block 210 converts (such as demultiplexes) serial modulated symbols into parallel data to generate N parallel symbol streams, where Nis a size of the IFFT/FFT used in the gNB 102 and the UE 116. The size N IFFT block 215 performs IFFT operations on the N parallel symbol streams to generate a time-domain output signal. The parallel-to-serial block 220 converts (such as multiplexes) parallel time-domain output symbols from the size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. It may also filter the signal at a baseband before converting to the RF frequency.

The RF signal transmitted from the gNB 102 arrives at the UE 116 after passing through the wireless channel, and operations in reverse to those at the gNB 102 are performed at the UE 116. The down-converter 255 down-converts the received signal to a baseband frequency, and the cyclic prefix removal block 260 removes the cyclic prefix to generate a serial time-domain baseband signal. The serial-to-parallel block 265 converts the time-domain baseband signal into a parallel time-domain signal. The size N FFT block 270 performs an FFT algorithm to generate N parallel frequency-domain signals. The parallel-to-serial block 275 converts the parallel frequency-domain signals into a sequence of modulated data symbols. The channel decoding and demodulation block 280 demodulates and decodes the modulated symbols to recover the original input data stream.

Each of the gNBs 101-103 may implement a transmission path 200 similar to that for transmitting to the UEs 111-116 in a downlink, and may implement a reception path 250 similar to that for receiving from the UEs 111-116 in an uplink. Similarly, each of the UEs 111-116 may implement a transmission path 200 for transmitting to the gNBs 101-103 in an uplink, and may implement a reception path 250 for receiving from the gNBs 101-103 in a downlink.

Each of the components in FIGS. 2A and 2B may be embodied in only hardware, or in a combination of hardware and software/firmware. As a specific example, at least some of the components in FIGS. 2A and 2B may be embodied in software, while other components may be embodied in configurable hardware or a combination of software and configurable hardware. For example, the FFT block 270 and IFFT block 215 may be embodied as configurable software algorithms, in which the value of the size N may be modified according to the implementation.

Furthermore, although described as using FFT and IFFT, this is only illustrative and should not be interpreted as limiting the scope of this disclosure. Other types of transforms may be used, such as Discrete Fourier Transform (DFT) and Inverse Discrete Fourier Transform (IDFT) functions. It should be understood that for DFT and IDFT functions, the value of variable N may be any integer (such as 1, 2, 3, 4), while for FFT and IFFT functions, the value of variable N may be any integer which is a power of 2 (such as 1, 2, 4, 8, 16).

Although FIGS. 2A and 2B illustrate examples of wireless transmission and reception paths, various changes may be made to FIGS. 2A and 2B. For example, various components in FIGS. 2A and 2B may be combined, further subdivided or omitted, and additional components may be added according to specific requirements. Furthermore, FIGS. 2A and 2B are intended to illustrate examples of types of transmission and reception paths that can be used in a wireless network. Any other suitable architecture may be used to support wireless communication in a wireless network.

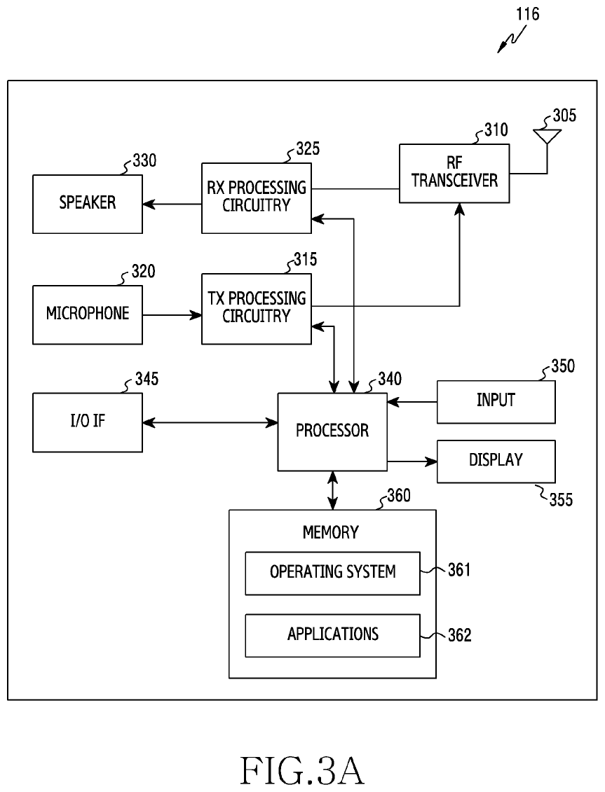

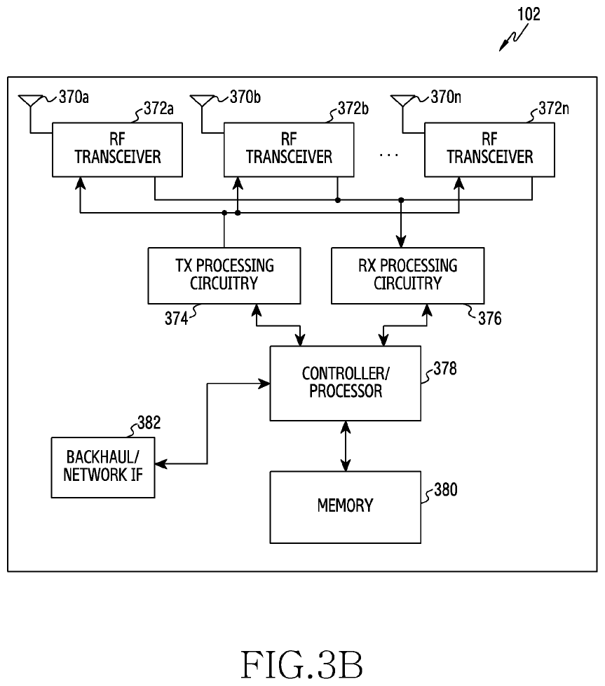

FIG. 3A illustrates an example UE 116 according to this disclosure. The embodiment of the UE 116 shown in FIG. 3A is for illustration only, and the UEs 111-115 of FIG. 1 may have the same or similar configuration. However, a UE has various configurations, and FIG. 3A does not limit the scope of this disclosure to any specific implementation of the UE.

The UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to the speaker 330 (such as for voice data) or to the processor/controller 340 for further processing (such as for web browsing data).

The TX processing circuit 315 receives analog or digital voice data from the microphone 320 or other outgoing baseband data (such as network data, email, or interactive video game data) from the processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 may include one or more processors or other processing devices and execute an OS 361 stored in the memory 360 in order to control the overall operation of the UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of this disclosure. The processor/controller 340 can move data into or out of the memory 360 as required by an execution process. In some embodiments, the processor/controller 340 is configured to execute the application 362 based on the OS 361 or in response to signals received from the gNB or the carrier. The processor/controller 340 is also coupled to the I/O interface 345, where the I/O interface 345 provides the UE 116 with the capability to connect to other devices such as laptop computers and handheld computers. The I/O interface 345 is a communication path between these accessories and the processor/controller 340.

The processor/controller 340 is also coupled to the input device(s) 350 and the display 355. An operator of the UE 116 can input data into the UE 116 using the input device(s) 350. The display 355 may be a liquid crystal display or another display capable of presenting text and/or at least limited graphics (such as from a website). The memory 360 is coupled to the processor/controller 340. A part of the memory 360 may include a random access memory (RAM), while another part of the memory 360 may include a flash memory or another read-only memory (ROM).

Although FIG. 3A illustrates an example of the UE 116, various changes may be made to FIG. 3A. For example, various components in FIG. 3A may be combined, further subdivided or omitted, and additional components may be added according to specific requirements. As a specific example, the processor/controller 340 may be divided into a plurality of processors, such as one or more central processing units (CPU) and one or more graphics processing units (GPU). Furthermore, although FIG. 3A illustrates that the UE 116 is configured as a mobile phone or a smart phone, the UEs may be configured to operate as other types of mobile or fixed devices.

FIG. 3B illustrates an example gNB 102 according to this disclosure. The embodiment of the gNB 102 shown in FIG. 3B is for illustration only, and other gNBs of FIG. 1 may have the same or similar configuration. However, a gNB has various configurations, and FIG. 3B does not limit the scope of this disclosure to any specific implementation of a gNB. It should be noted that the gNB 101 and the gNB 103 may include the same or similar structures as the gNB 102.

As shown in FIG. 3B, the gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. The gNB 102 also includes a controller/processor 378, a memory 380, and a backhaul or network interface 382.

The RF transceivers 372a-372n receive an incoming RF signal from the antennas 370a-370n, such as a signal transmitted by a UE or another gNB. The RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. The RX processing circuit 376 transmits the processed baseband signal to the controller/processor 378 for further processing.

The TX processing circuit 374 receives analog or digital data (such as voice data, network data, email, or interactive video game data) from the controller/processor 378. The TX processing circuit 374 encodes, multiplexes and/or digitizes outgoing baseband data to generate a processed baseband or IF signal. The RF transceivers 372a-372n receive the outgoing processed baseband or IF signal from the TX processing circuit 374 and up-convert the baseband or IF signal into an RF signal transmitted via the antennas 370a-370n.

The controller/processor 378 can include one or more processors or other processing devices that control the overall operation of the gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a blind interference sensing (BIS) process such as that performed through a BIS algorithm, and decode a received signal from which an interference signal is subtracted. A controller/processor 378 may support any of a variety of other functions in the gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of this disclosure. In some embodiments, the controller/processor 378 supports communication between entities such as web real-time communications (RTCs). The controller/processor 378 can move data into or out of the memory 380 as required by an execution process.

The controller/processor 378 is also coupled to the backhaul or network interface 382. The backhaul or network interface 382 allows the gNB 102 to communicate with other devices or systems through a backhaul connection or through a network. The backhaul or network interface 382 can support communication over any suitable wired or wireless connection(s). For example, when the gNB 102 is embodied as a part of a cellular communication system, such as a cellular communication system supporting 5G or new radio access technology or NR, LTE or LTE-A, the backhaul or network interface 382 may allow the gNB 102 to communicate with other gNBs through wired or wireless backhaul connections. When the gNB 102 is embodied as an access point, the backhaul or network interface 382 can allow the gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions is configured to cause the controller/processor 378 to execute the BIS process and decode the received signal after subtracting at least one interference signal determined by the BIS algorithm.

As will be described in more detail below, the transmission and reception paths of the gNB 102 (embodied by using the RF transceivers 372a-372n, the TX processing circuit 374 and/or the RX processing circuit 376) support aggregated communication with FDD cells and TDD cells.

Although FIG. 3B illustrates an example of gNB 102, various changes may be made to FIG. 3B. For example, the gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, the gNB 102 can include multiple instances of each (such as one for each RF transceiver).

Exemplary embodiments of the present disclosure are further described below with reference to the accompanying drawings.

The text and drawings are provided as examples only to help readers understand this disclosure. They are not intended and should not be interpreted as limiting the scope of this disclosure in any way. Although certain embodiments and examples have been provided, based on the disclosure herein, it will be apparent to those skilled in the art that changes may be made to the illustrated embodiments and examples without departing from the scope of the present disclosure.

The technical solution of the embodiments of the present application may be applied to various communication systems, for example, a global system for mobile communications (GSM), a code division multiple access (CDMA) system, a wideband code division multiple access (WCDMA) system, a general packet radio service (GPRS) system, a long term evolution (LTE) system, an LTE frequency division duplex (FDD) system, an LTE time division duplex (TDD) system, a universal mobile telecommunication system (UMTS), a worldwide interoperability for microwave access (WiMAX) communication system, a 5th generation (5G) system or a new radio (NR) system, or the like. Furthermore, the technical solution of the embodiments of the present application may be applied to future communication technologies.

With the development of 5G systems, in order to provide users with better communication services, such as providing communication services at any place at any time, especially in scenarios with coverage areas such as mountains, oceans, deserts, and the like, support of satellite communication systems has been introduced in the 5G communication system due to the advantages of longer communication distance and larger coverage area. In the standard TR 3GPP 38.811, according to the type and orbital altitude of satellites, the satellite communication systems may be divided into synchronous orbit or geostationary Earth orbit (referred to as GEO) satellite communication systems, and non-synchronous orbit or non-geostationary satellites communication systems. Non-synchronous orbit satellite communication systems, based on the orbital altitude of satellites, may be divided into Medium Earth Orbit (MEO) (referred to as Medium Orbit for short) satellite communication systems and Low Earth Orbit (LEO) (referred to as Low Orbit for short) satellite communication systems. At present, the performance of cell measurement needs to be further improved, so an enhanced cell measurement method is needed to improve the performance of cell measurement. Embodiments of the present disclosure relate to a method and a device for performing cell measurement in a communication system. In the present disclosure, a satellite communication system is taken as an example to illustrate the method. However, the cell measurement method may also be applied to other communication systems without departing from the scope of the present disclosure.

When a user equipment (UE) is in an idle (radio resource control (RRC)_IDLE) state or an inactive (RRC_INACTIVE) state, the UE may reselect and camp on a more suitable cell through a cell reselection process.

The specific process of cell reselection performed by a UE is as follows:

The UE may measure a synchronization signal-reference signal received power (SS-RSRP) and/or synchronization signal-reference signal received quality (SS-RSRQ) of a serving cell for at least M1*N1 discontinuous reception cycles (DRX), and evaluate whether the serving cell meets predetermined criteria. In case that the UE evaluates that within Nserv consecutive DRX cycles, the serving cell does not fulfil the predetermined criteria, then the UE may initiate measurement of a neighbouring cell, regardless of the current measurement rules that restrict the UE. The neighbouring cell measurement includes intra-frequency measurement and inter-frequency measurement.

Wherein M1=1, 2 or other values. M1 is determined based on a mapping table of a synchronization signal block measurement timing configuration (SMTC: synchronization signal block (SSB) Measurement Timing Configuration) and/or the DRX cycle. N1 is a scaling factor, determined based on the frequency range and/or terminal type or terminal antenna type mapping table. Nserv is determined based on a mapping table of M1 and/or N1.

In a communication system, a specific process for an enhanced cell measurement and reselection process includes:

A base station (in the case of a satellite communication system, it may be a satellite of the serving cell) periodically transmits system information. In addition to parameters in traditional technologies, the system information should include at least one of the following:
serving cell type (for example, fixed beams or moving beams);
a list of neighbouring cells (the list of neighbouring cells is a list that includes information of at least one neighbouring cell. Each entry in the list is for a neighbouring cell. For each neighbouring cell, the list may include at least one of the following information related to the corresponding neighbouring cell: fixed beam or moving beam, a cell identifier, frequency information, or a priority);
a cell stop time of the serving cell to the coverage area;
time information of a reference location of the serving cell and/or each neighbouring cell;
a distance threshold list of the serving cell that contains at least one of the following: a first distance threshold (a distance threshold in the normal measurement mode that does not require intra-frequency or inter-frequency measurement of a neighbouring cell), a third distance threshold (a distance threshold in the relaxed measurement mode). In one embodiment, the distance threshold list may be a new distance threshold list. In another embodiment, the distance threshold list may be a reused distance threshold list;
optionally, in the list of neighbouring cells, a second distance threshold corresponding to each cell (a distance threshold requires intra-frequency or inter-frequency measurement of a neighbouring cell);
optionally, a coverage area size of the serving cell, such as a cell radius or a beam coverage area diameter (a beam footprint size); and/or
optionally, a list of beam directions, beam coverage angles and angle thresholds of the serving cell and/or neighbouring cells.

In an example embodiment, the UE receives the periodic information sent by the base station at a first time T1. In case that the serving cell has configured a cell stop time for the coverage area and includes the cell stop time in the periodic information, then the UE measures a moving direction and a moving velocity of the UE to obtain a second time T2, and a measurement of any neighbouring cells of the UE needs to be completed before the end of the second time T2. For example, to obtain the second time T2, the moving direction of the UE may be compared with the moving direction of the serving cell. In case that the moving direction of the UE and the moving direction of the serving cell (such as the moving direction of a satellite) are opposite to each other on at least one of axes X and Y (for example, two mutually orthogonal axes parallel to the earth's surface), then the second time T2 is obtained by subtracting an offset from the cell stop time. Otherwise, the second time T2 is obtained by adding an offset to the cell stop time. The offset may be a preset value set according to the maximum allowed UE velocity, and/or may be obtained by looking up a table according to the UE velocity. The correct cell reselection rate is improved by more accurately determining the UE measurement time to avoid redundant neighbouring cell measurements or missing neighbouring cell measurements.

In the following description, a normal mode neighbouring cell measurement by the UE means that the UE may evaluate whether a new detectable cell meets the reselection criteria within Tdetect (in Table 1).

The UE may measure SS-RSRP/SS-RSRQ at least every Tmeasure (in Table 1).

For a cell that has been detected but has not been reselected to, the UE may evaluate that the cell meets the reselection criteria within Tevaluate (in Table 1).

A relaxed mode neighbouring cell intra-frequency or inter-frequency measurement performed by the UE means that:
the above-mentioned Tdetect or Tmeasure or Tevaluate is replaced by the above-mentioned normal measurement time or period multiplied by a multiple factor K or fixed values greater than the corresponding values in the normal mode are defined.

TABLE 1

| DRX | T_{detect} [s] | Tₘₑₐₛᵤᵣₑ [s] | Tₑᵥₐₗᵤₐₜₑ [s] |
|---|---|---|---|
| cycle | (number of | (number of | (number of |
| length [s] | DRX cycles) | DRX cycles) | DRX cycles) |
| 0.32 | 2.56 × M2 | 0.32 × M3 | 0.96 × M4 |
| | (8 × M2)^{Note 1} | (1 × M3)^{Note 1} | (3 × M4)^{Note 1} |
| 0.64 | 5.12 (8) | 0.64 (1) | 1.92 (3) |
| 1.28 | 8.96 (7) | 1.28 (1) | 3.84 (3) |
| 2.56 | 58.88 (23) | 2.56 (1) | 7.68 (3) |

^{Note 1}
When SMTC <= 40 ms, M2 = M3 = M4 = 1; and when SMTC > 40 ms, M2 = 2, M3 = M4 = 2.5

The values of the number of DRX cycles in the table are examples and may be modified to other values appropriately.

According to an embodiment, a method performed by a user equipment UE in a wireless communication system according to an embodiment of the present disclosure includes receiving first information from a base station, wherein the first information at least includes a cell stop time of a serving cell and stopping, by the UE, measurement of a neighbouring cell before a second time, wherein the second time is determined based on the first information.

According to an embodiment, the second time is determined based on the first information and an offset.

According to an embodiment, when a moving direction of the UE meets a first condition, the second time is determined by subtracting the offset from the cell stop time contained in the first information. otherwise, the second time is determined by adding the offset to the cell stop time contained in the first information.

According to an embodiment, the first condition includes: the moving direction of the UE is opposite to the moving direction of the serving cell.

According to an embodiment, the offset is one of: a predetermined value; a value determined based on a mapping table of a UE velocity to the offset; and a value determined based on a predetermined function. The predetermined function is related to at least one of a coverage range of the serving cell, a UE location, a moving direction of the UE, a moving velocity of the UE, a location of the serving cell, a moving direction of the serving cell, and a moving velocity of the serving cell.

According to an embodiment, a method performed by a base station in a wireless communication system according to an embodiment of the present disclosure includes transmitting first information to a user equipment UE, wherein the first information at least includes a cell stop time of a serving cell; and stopping, by the UE, measurement of a neighbouring cell before a second time, wherein the second time is determined based on the first information.

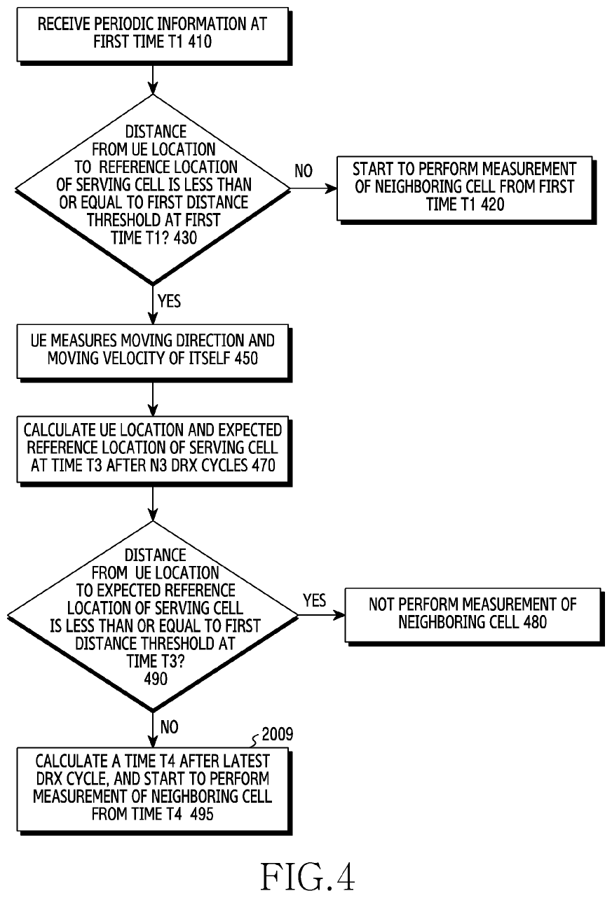

FIG. 4 illustrates a first example of flowchart of a cell measurement process performed by a UE. In FIG. 4, in step 410, the UE receives periodic information (such as system information) sent by a base station at a first time T1. In case that the periodic information received at the first time T1 includes time information of a reference location of a serving cell, then the UE calculates a distance from a UE location to a reference location of the serving cell at the first time T1.

In step 430, in case that the distance from the UE location to the reference location of the serving cell is less than or equal to a distance threshold configured by the base station that does not require to perform intra-frequency or inter-frequency measurement of a neighbouring cell (also known as a first distance threshold) at the first time T1, then in step 450, the UE measures a moving direction and a moving velocity of itself, and based at least in part on the moving direction and moving velocity of the UE, calculates in step 470 a UE location and an expected reference location of the serving cell at a time T3 after N3 discontinuous reception (DRX) cycles.

In step 490, in case that the distance from the UE location to the expected reference location of the serving cell is still less than or equal to the distance threshold configured by the base station that does not require to perform intra-frequency or inter-frequency measurement of a neighbouring cell at the time T3, then in step 480, the UE does not perform intra-frequency or inter-frequency measurements of neighbouring cells.

In step 490, in case that the distance from the UE location to the expected reference location of the serving cell is already greater than the distance threshold configured by the base station that does not require to perform intra-frequency or inter-frequency measurement of a neighbouring cell at the time T3, then in step 495, the UE calculates a time T4 after the latest DRX cycle, and starts measurement of a neighbouring cell in a normal mode from the time T4.

In step 430, in case that the distance from the UE location to the reference location of the serving cell is greater than the first distance threshold at the first time T1, then in step 420, the UE starts performing measurement of a neighbouring cell in a normal mode from the first time T1.

The value of the above number N3 of DRX cycles is related to the DRX cycles.

Optionally, calculating the UE location at the time T3 after N3 DRX cycles based on the moving direction and moving velocity of the UE itself may be performed only when the moving velocity of the UE meets (for example, is greater than or equal to) a velocity threshold TH1.

Determining whether the UE performs the cell measurement through more accurate time and location prediction to avoid redundant neighbouring cell measurements or missing neighbouring cell measurements improves the correct cell reselection rate.

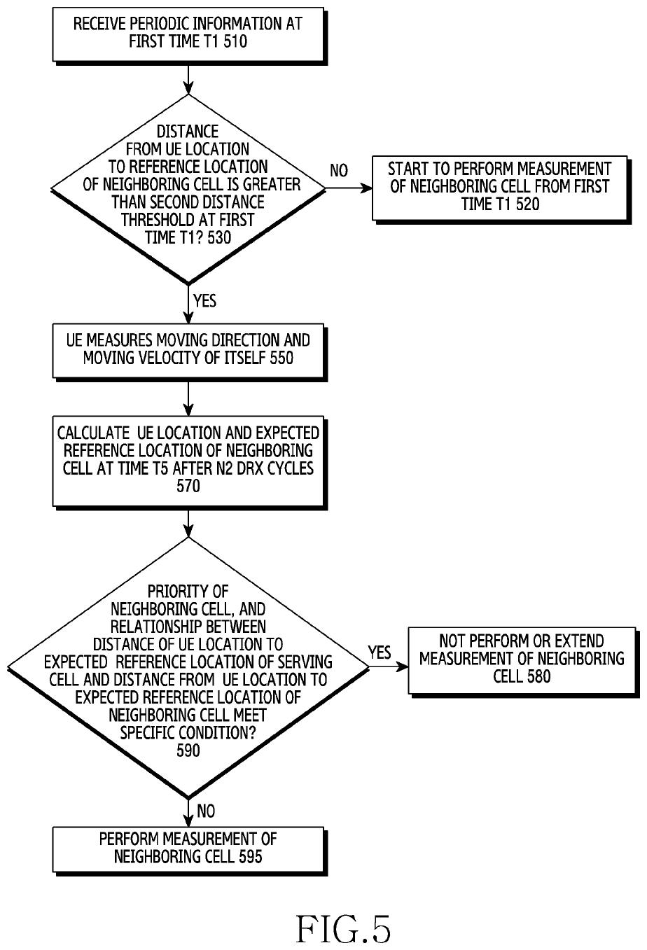

FIG. 5 illustrates a second example of flowchart of a cell measurement process performed by a UE. In FIG. 5, in step 510, a UE receives periodic information (for example, system information) sent by a base station at a first time T1. Optionally, in case that the periodic information sent by the base station received by the UE at the first time T1 contains time information of a reference location of a neighbouring cell, then the UE calculates a distance from a UE location to the reference location of the neighbouring cell at the first time T1.

In step 530, in case that the distance from the UE location to the reference location of the neighbouring cell is greater than a distance threshold configured by the base station that requires to perform intra-frequency or inter-frequency measurement of a neighbouring cell (also known as a second distance threshold) at the first time T1, then in step 550, the UE measures a moving direction and a moving velocity of itself, and based at least in part on the moving direction and moving velocity of the UE, calculates in step 570 a UE location and an expected reference location of the neighbouring cell at a time T5 after N2 discontinuous reception (DRX) cycles.

In step 590, the UE determines whether a condition is met according to a priority of the neighbouring cell, and a relationship between a distance of the UE location to an expected reference location of the serving cell at the time T5 and the distance from the UE location to the expected reference location of the neighbouring cell at the time T5, and in case that the condition is met, then in step 580, the UE may not perform intra-frequency or inter-frequency measurements of the neighbouring cell. Otherwise, in step 595, the UE performs intra-frequency or inter-frequency measurement of the neighbouring cell. In one embodiment, for example, if compared with the serving cell, the priority of the neighbouring cell is lower or the same, and the distance from the UE location to the expected reference location of the neighbouring cell is greater than the distance from the UE location to the expected reference location of the serving cell at the time T5, then the UE may not perform measurement of the neighbouring cell. In another embodiment, if compared with the serving cell, the priority of the neighbouring cell is higher or the same, and the distance from the UE location to the expected reference location of the neighbouring cell is smaller than the distance from the UE location to the expected reference location of the serving cell at the time T5, then the UE may perform the measurement in a relaxed mode.

If compared with the serving cell, the priority of the neighbouring cell is lower or the same, and the distance from the UE location to the expected reference location of the neighbouring cell is smaller than the distance from the UE location to the expected position reference point of the serving cell at the time T5, then the UE may perform measurement of the neighbouring cell in the normal mode. If compared with the serving cell, the priority of the neighbouring cell is higher, and the distance from the UE location to the expected reference location of the neighbouring cell is greater than the distance from the UE location to the expected reference location of the serving cell at the time T5, then the UE may perform measurement of the neighbouring cell in the relaxed mode. In another embodiment, for example, if compared with the serving cell, the priority of the neighbouring cell is lower or the same, and the distance from the UE location to the expected reference location of the neighbouring cell is greater than the second distance threshold at the time T5, then the UE may not perform measurement of the neighbouring cell.

In another embodiment, if compared with the serving cell, the priority of the neighbouring cell is higher or the same, and the distance from the UE location to the expected reference location of the neighbouring cell is less than the second distance threshold at the time T5, then the UE may perform the measurement in the relaxed mode. If compared with the serving cell, the priority of the neighbouring cell is lower or the same, and the distance from the UE location to the expected reference location of the neighbouring cell is less than the second distance threshold at the time T5, then the UE may perform measurement of the neighbouring cell in the normal mode. If compared with the serving cell, the priority of the neighbouring cell is higher, and the distance from the UE location to the expected reference location of the neighbouring cell is greater than the second distance threshold at the time T5, then the UE may perform measurement of the neighbouring cell in the relaxed mode.

According to an embodiment, calculating the UE location at the time T5 after N2 DRX cycles based on the moving direction and moving velocity of the UE itself may be performed only when the moving velocity of the UE meets (for example, is greater than or equal to) a velocity threshold TH2. The velocity threshold TH2 may be the same as or different from the TH1 above.

Determining whether the UE performs measurement of a neighbouring cell through more accurate time and location prediction of the neighbouring cell to avoid redundant neighbouring cell measurements or missing neighbouring cell measurements improves the correct cell reselection rate.

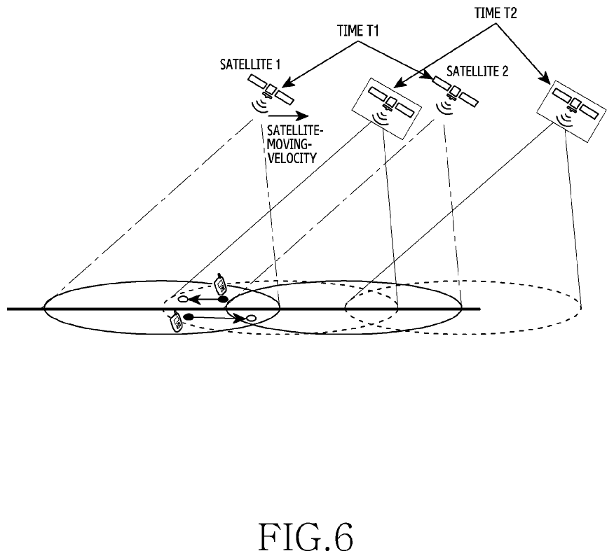

FIG. 6 illustrates an example of scenario in which cell measurement is performed according to various embodiments of the present disclosure.

Referring to FIG. 6, a serving cell is a coverage area of a satellite 1 (as a non-limiting example of a base station), and a neighbouring cell is a coverage area of a satellite 2 (as another non-limiting example of a base station). Initially, the UE is in an idle state and camps on a cell 1 as the serving cell. The UE receives periodic information (such as system information block (SIB)) sent by the base station at a time T1, and through the SIB, the UE is able to determine that the serving cell is of a mobile beam type. Through the SIB, the UE is also able to determine that the base station (for example, the satellite 1) configures a cell stop time T_stop of the coverage area of the cell 1. The UE measures its own moving direction and moving velocity, and the UE can obtain information such as the location, moving direction and moving velocity of the satellite and so on at a specific time from position velocity time (PVT) information or ephemeris information. In case that the moving directions of the UE and the satellite are opposite to each other on at least one of axes X and Y, then an offset is subtracted from the cell stop time T_stop, and measurement of any neighbouring cell by the UE needs to be completed before the time T_stop−offset.

Otherwise, an offset is added to the cell stop time T_stop, and measurement of any neighbouring cell by the UE needs to be completed before the cell stop time T_stop+offset. The offset may be a function related to the coverage area of the serving cell; the location, moving direction, and velocity of the UE; the location, moving direction, and velocity of the satellite; and other parameters. As a non-limiting example, the offset may be preset as a cell diameter/(satellite velocity−UE velocity). Those skilled in the art should understand that any suitable method may be used to determine the offset without departing from the scope of the present disclosure. For example, the offset may be a preset value set according to the maximum allowed UE velocity, and/or may be obtained by looking up a table according to the UE velocity.

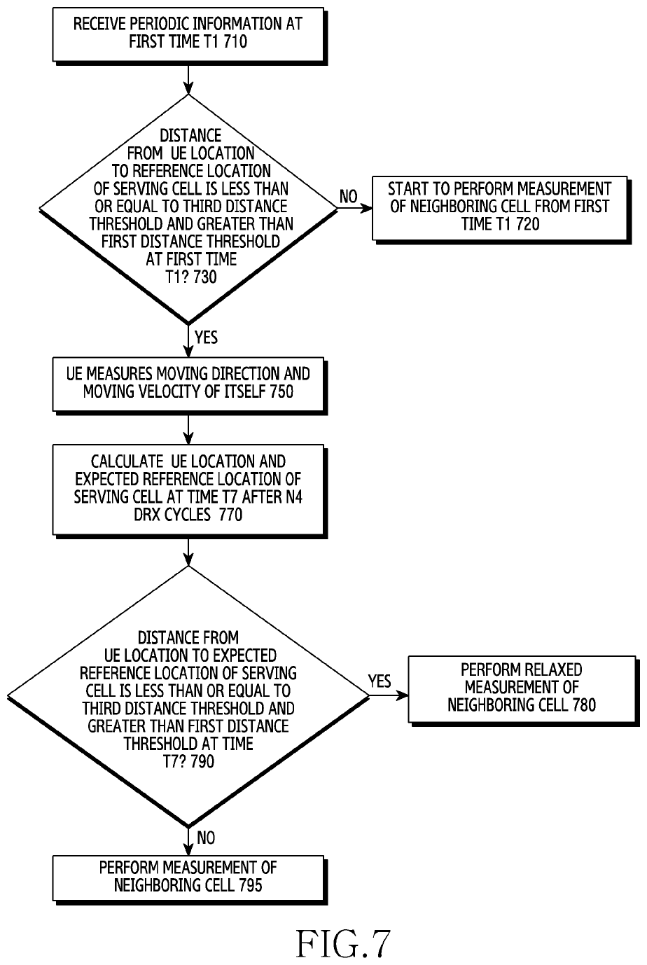

FIG. 7 illustrates an example of flowchart of a cell measurement process performed by a UE according to various embodiments of the present disclosure. Similar to FIG. 4, as shown in FIG. 7, in step 710, the UE receives periodic information (such as a system information block, SIB) sent by a base station at a first time T1. In case that the periodic information (for example, the SIB) received at the first time T1 includes time information of a reference location of a serving cell, then the UE calculates a distance from a UE location to a reference location of the serving cell at the first time T1.

In step 730, in case that the distance from the UE location to the reference location of the serving cell is less than or equal to a third distance threshold and greater than a first distance threshold at the first time T1, then in step 750, the UE measures a moving direction and a moving velocity of itself, and based at least in part on the moving direction and moving velocity of the UE and a minimum measurement time (for example, Tdetect, Tmeasure, Tevaluate in Table 1 or any combination thereof), calculates in step 770 a UE location and the expected reference location of the serving cell at a time T7 after N4 discontinuous reception (DRX) cycles (N4 is the number of measuring DRX cycles in Table 1).

In step 790, in case that the distance from the UE location to the expected reference location of the serving cell is still less than or equal to the third distance threshold and greater than the first distance threshold at the time T7, then in step 780, the UE performs measurement in a relaxed mode.

In step 790, in case that the distance from the UE location to the expected reference location of the serving cell is already greater than the third distance threshold at the time T7, then in step 795, the UE calculates a time T4 after the latest DRX cycle, and starts performing intra-frequency or inter-frequency measurement of the neighbouring cell in a normal mode from the time T4.

In step 730, in case that the distance from the UE location to the reference location of the serving cell is greater than the third distance threshold at the first time T1, then in step 720, the UE starts performing intra-frequency or inter-frequency measurement of the neighbouring cell in the normal mode from the first time T1.

According to an embodiment, calculating the UE location at the time T3 after N3 DRX cycles based on the moving direction and moving velocity of the UE itself may be performed only when the moving velocity of the UE meets (for example, is greater than or equal to) the velocity threshold TH1.

According to an embodiment, a method performed by a user equipment UE in a wireless communication system according to example embodiments of the present disclosure includes: receiving first information from a base station; and determining whether to perform measurement of a neighbouring cell according to the first information, wherein the first information includes time information of a reference location of a serving cell.

According to an embodiment, the first information also includes a first distance threshold or a third distance threshold of the serving cell, or a list of neighbouring cells, wherein the list of neighbouring cells includes the time information of a reference location of each neighbouring cell and a second distance threshold.

According to an embodiment, in the case that the first information includes time information of the reference location of the serving cell and the first distance threshold, the determining whether to perform measurement of the neighbouring cell includes at least one of: stopping, by the UE, measurement of the neighbouring cell before a second time, the second time is determined based on the first information and the offset; performing measurement of the neighbouring cell in a case that a distance from a UE location to the reference location of the serving cell is less than or equal to the first distance threshold at the first time, and a distance from a UE location to the expected reference location of the serving cell is greater than the first distance threshold at a third time; and not performing measurement of the neighbouring cell in a case that the distance from the UE location to the reference location of the serving cell is less than or equal to the first distance threshold at the first time, and the distance from the UE location to the expected reference location of the serving cell is less than or equal to the first distance threshold at the third time.

According to an embodiment, in the case where the first information includes the time information of the reference location of the serving cell, time information of a reference location of a neighbouring cell, and the second distance threshold, the determining whether to perform measurement of the neighbouring cell includes at least one of: stopping, by the UE, measurement of the neighbouring cell before the second time, the second time is determined based on the first information and the offset; not performing measurement of the neighbouring cell, or relaxing measurement of the neighbouring cell, in a case that a distance from the UE location to the reference location of the neighbouring cell is greater than the second distance threshold at the first time, a distance from a UE location to the expected reference location of the neighbouring cell is greater than a distance from the UE location to the expected reference location of the serving cell at a fifth time, and a priority of the neighbouring cell is lower than or equal to a priority of the serving cell; performing measurement of the neighbouring cell in a case that the distance from the UE location to the reference location of the neighbouring cell is greater than the second distance threshold at the first time, and the distance from the UE location to the expected reference location of the neighbouring cell is less than the distance from the UE location to the expected reference location of the serving cell at a fifth time, and the priority of the neighbouring cell is higher than, equal to, or lower than that of the serving cell; performing measurement of the neighbouring cell in a case that the distance from the UE location to the expected reference location of the neighbouring cell is greater than the distance from the UE location to the expected reference location of the serving cell at a fifth time, and the priority of the neighbouring cell is higher than the priority of the serving cell.

According to an embodiment, in a case that the first information includes the time information of the reference location of the serving cell and the third distance threshold, the determining whether to perform measurement of a neighbouring cell includes at least one of: stopping, by the UE, measurement of the neighbouring cell before the second time, the second time is determined based on the first information and the offset, performing measurement of the neighbouring cell according to a relaxed measurement period in a case that the distance from the UE location to the reference location of the serving cell is less than or equal to the third distance threshold at the first time, and a distance from a UE location to an expected reference location of the serving cell is less than or equal to the third distance threshold at a seventh time and/or performing measurement of the neighbouring cell in a case that the distance from the UE location to the reference location of the serving cell is greater than the third distance threshold at the first time; performing measurement of the neighbouring cell in a case that the distance from the UE location to the reference location of the serving cell is less than or equal to the third distance threshold at the first time, and the distance from the UE location to the expected reference location of the serving cell is greater than the third distance threshold at the seventh time.

According to an embodiment, the UE location is determined based on a moving direction and a moving velocity of the UE in a case that the velocity of the UE is greater than or equal to a specific threshold.

According to an embodiment, the relaxed measurement period is based on a predetermined value. The predetermined value is greater than a normal measurement period.

According to an embodiment, the first distance threshold is a distance threshold for a normal measurement; the second distance threshold is a distance threshold for measurement of a neighbouring cell and the third distance threshold is a distance threshold for relaxed measurements.

According to an embodiment, the first information further includes at least one of a type of the serving cell, a cell stop time of the serving cell, a coverage area size of the serving cell, a beam direction and a coverage angle of the serving cell, a beam direction and a coverage angle of the neighbouring cell, and an angle threshold.

According to an embodiment, the third time is a time after receiving N3 discontinuous reception DRX cycles.

According to an embodiment, the fifth time is a time after receiving N2 discontinuous reception DRX cycles.

According to an embodiment, the seventh time is a time after receiving N4 discontinuous reception DRX cycles.

According to an embodiment, the reference location of the serving cell is related to an altitude of the UE.

According to an embodiment, a method performed by a base station in a communication system according to example embodiments of the present disclosure includes transmitting first information to a user equipment UE and receiving an uplink transmission signaling from the UE. wherein the first information is used by the UE to determine whether to perform measurement of a neighbouring cell, and the first information includes time information of a reference location of a serving cell.

According to an embodiment, the first information further includes at least one of: a first distance threshold of the serving cell, a third distance threshold of the serving cell, a type of the serving cell, and a cell stop time of the serving cell, a coverage area size of the serving cell, a beam direction and a coverage angle of the serving cell, a list of neighbouring cells, a beam direction and a coverage angle of the neighbouring cell, an angle threshold, wherein the list of neighbouring cells includes time information of a reference location of each neighbouring cell and a second distance threshold.

According to an embodiment, in each of the above methods, in case that the altitude of the UE is higher than a preset value, then the altitude needs to be included in the calculation of the expected reference location. This includes one of the following methods:

In case that the reference location sent by the base station is based on the earth's surface or the center of the earth, the expected reference location taken by the UE to compare the distance needs to be calculated by introducing the altitude, and the expected reference location and the UE altitude are on a same plane parallel to the earth's surface.

In case that the reference location and distance threshold sent by the base station are a mapping table based on different altitude sets, and each altitude set corresponds to a set of reference locations and distance thresholds, then the expected reference location and distance threshold may be obtained by the UE by looking up the table. For example:
The altitude is h1 meters, corresponding to distance 1 (D1) and Thresh1;
The altitude is h2 meters, corresponding to distance 2 (D2) and Thresh2; and
The altitude is h4 meters, corresponding to distance 3 (D3) and Thresh3, and so on. When the UE altitude ranges from h1 to h2, the UE uses the D1 and the Thresh1 in the first information.

According to an embodiment, a method performed by a user equipment UE in a wireless communication system according to example embodiments of the present disclosure includes: receiving first information from a base station; and determining whether to perform measurement of a neighbouring cell according to the first information, wherein the first information includes a reference location list and a distance threshold list of a serving cell, and each reference location or distance threshold in the lists corresponds to a specific altitude range.

According to an embodiment, the determining whether to perform measurement of the neighbouring cell based on the first information includes: determining, by the UE, whether to perform measurement of the neighbouring cell based on a reference location and a distance threshold corresponding to the altitude of the UE.

In case that the UE is a very small aperture satellite communication terminal (VSAT) and an antenna is of a directional antenna type, the UE may replace the distance in the above process with determining a viewing angle or determining of the viewing angle may be added to the distance in the above process. The UE uses a beam direction and a beam coverage range sent by the base station to predict the viewing angle. Following examples are provided.

The UE receives periodic information sent by the base station at the first time T1, including a beam direction, a coverage angle, and an angle threshold of a serving cell and/or a neighbouring cell. The UE calculates the satellite viewing angle at the first time T1. In case that the base station is in a viewing area of the UE, for example, if the direction of the UE antenna+the UE beam coverage angle/2 is greater than the satellite viewing angle lower limit−the angle threshold, or the direction of the UE antenna−the UE beam coverage angle/2 is less than the upper limit of the satellite viewing angle+the angle threshold, then the UE performs measurement of the neighbouring cell in a normal mode. Otherwise, the UE does not perform measurement of the neighbouring cell. Optionally, if the satellite associated with the base station is mobile, the angle prediction at the next time may be added before performing judgment of a condition. Another condition for determining that the base station is in the viewing area of the UE is that the UE's antenna direction ground angle is greater than the lowest visible ground angle of the satellite.

According to an embodiment, a method performed by a user equipment UE in a wireless communication system according to example embodiments of the present disclosure includes: receiving first information from a base station; and determining whether to perform measurement of a neighbouring cell based on the first information, wherein the first information includes a beam direction and a beam coverage range of a serving cell and/or the neighbouring cell.

According to an embodiment, the determining whether to perform measurement of the neighbouring cell includes at least one of: stopping, by the UE, measurement of the neighbouring cell before a second time, the second time being determined based on the first information and an offset; performing measurement of the neighbouring cell when the UE is within a viewing range of a satellite; otherwise, not performing measurement of the neighbouring cell.

Those skilled in the art should understand that “user equipment” or “UE” herein may refer to any terminal capable of wireless communication, including but not limited to a mobile phone, a cellular phone, a smart phone, a personal digital assistants (PDA), a portable computer, an image capture device such as a digital camera, a gaming device, a music memory and playback device, and any portable unit or terminal capable of wireless communication, or Internet facilities allowing wireless Internet access and browsing.

As used herein, the term “base station” (BS) or “network equipment” may refer to an eNB, an eNodeB, a NodeB or a base station transceiver (BTS) or a gNB according to the technology and terminology used.

The “memory” herein may be any type suitable for the technical environment herein, and may be implemented using any suitable data memory technology, including but not limited to a semiconductor-based memory device, a magnetic memory device and system, an optical memory device and system, a fixed memory and a removable memory.

The processor herein may be any type suitable for the technical environment herein, including but not limited to one or more of the following: a general-purpose computer, a specialized computer, a microprocessor, a digital signal processor DSP, and a processor based on a multicore processor architecture.

The above provides only preferred embodiments of this disclosure and is not intended to limit this disclosure. Any modification, equivalent replacement, improvement, and the like made within the spirit and principle of this disclosure shall fall within the patentable scope of this disclosure.

Those skilled in the art may understand that this disclosure relates to devices for performing one or more of the operations described in this disclosure. These devices can be specifically designed and manufactured for the desired purpose, or they can also include known devices found in general-purpose computers. These devices have computer programs stored within them, which are selectively activated or reconstructed. Such computer programs may be stored in a device (e.g., a computer) readable medium or stored in any type of media suitable for storing electronic instructions and separately coupled to a bus, wherein the computer-readable medium includes, but is not limited to, any type of disk (including a floppy disk, a hard disk, an optical disk, a CD-ROM, and a magneto-optical disk), a ROM (read-only memory), a RAM (random access memory), an EPROM (erasable programmable read-only memory), an EEPROM (electrically erasable programmable read-only memory), a flash memory, a magnetic card or a light card. That is, readable medium includes any medium that stores or transmits information by a device (e.g., a computer) in a form capable of being readable.

Those skilled in the art may understand that each block in these structure diagrams and/or block diagrams and/or flow diagrams and combinations of blocks in these structure diagrams and/or block diagrams and/or flow diagrams may be implemented with computer program instructions. Those skilled in the art may understand that these computer program instructions may be provided to a general purpose computer, a specialized computer or another processor with other programmable data processing methods for implementation, thereby performing the solution indicated in one or more blocks in structure diagram and/or block diagram and/or flow diagram disclosed in this disclosure by a computer or a processor with other programmable data processing methods.

Those skilled in the art can recognize that this disclosure can be implemented in other specific forms without changing the technical idea or essential features of this disclosure. Therefore, it should be understood that the above embodiments are merely examples and are not limiting. The scope of this disclosure is defined by the appended claims, rather than the detailed description. Therefore, it should be understood that all modifications or changes and their equivalents derived from the meaning and scope of the appended claims are within the scope of this disclosure.

In the above embodiments of the present disclosure, all operations and steps may be selectively performed or may be omitted. Furthermore, the operations and steps in each embodiment need not be performed sequentially, and the order of operations and steps may vary.

While this disclosure has been shown and described with reference to various embodiments of this disclosure, those skilled in the art may appreciate that, without departing from the spirit and scope of this disclosure as defined by the appended claims and their equivalents, variations may be made to the form and detail thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving, from a base station, a system information block (SIB) including information on a threshold for a location-based measurement in a radio resource control (RRC) idle or RRC inactive and information on a reference location of a serving cell; and
in case that a distance between the UE in the RRC idle or the RRC inactive and the reference location of the serving cell is larger than the threshold, performing the location-based measurement for cell reselection.

2. The method of claim 1, wherein the location-based measurement for the cell reselection is performed, in case that location information of the UE is obtained.

3. The method of claim 1, wherein the SIB further includes information on a list of neighbour cells.

4. The method of claim 3, wherein the information on the list of the neighbour cells includes information on a frequency and information on a cell identity (ID).

5. The method of claim 1, further comprising:
camping on a cell which meets reselection criterion based on the location-based measurement.

6. The method of claim 1, wherein the SIB further includes coverage information of the serving cell.

7. The method of claim 1, further comprising:
performing a time-based measurement based on information associated with time the serving cell stops serving an area in which the UE is included.

8. The method of claim 1, wherein the information on the reference location is referenced to time.

9. The method of claim 1, wherein the serving cell is associated with an earth moving system.

10. The method of claim 1, wherein the location-based measurement includes an intra-frequency measurement or an inter-frequency measurement.

11. A user equipment (UE) in a wireless communication system, the UE comprising:
a transceiver; and
a controller coupled with the transceiver and configured to:
receive, from a base station, a system information block (SIB) including information on a threshold for a location-based measurement in a radio resource control (RRC) idle or RRC inactive and information on a reference location of a serving cell, and
in case that a distance between the UE in the RRC idle or the RRC inactive and the reference location of the serving cell is larger than the threshold, perform the location-based measurement for cell reselection.

12. The UE of claim 11, wherein the location-based measurement for the cell reselection is performed, in case that location information of the UE is obtained.

13. The UE of claim 11, wherein the SIB further includes information on a list of neighbour cells.

14. The UE of claim 13, wherein the information on the list of the neighbour cells includes information on a frequency and information on a cell identity (ID).

15. The UE of claim 11, wherein the controller is further configured to:
camp on a cell which meets reselection criterion based on the location-based measurement.

16. The UE of claim 11, wherein the SIB further includes coverage information of the serving cell.

17. The UE of claim 11, wherein the controller is further configured to:
perform a time-based measurement based on information associated with time the serving cell stops serving an area in which the UE is included.

18. The UE of claim 11, wherein the information on the reference location is referenced to time.

19. The UE of claim 11, wherein the serving cell is associated with an earth moving system.

20. The UE of claim 11, wherein the location-based measurement includes an intra-frequency measurement or an inter-frequency measurement.
